(19) United States
(12) Patent Application Publication
(10) Pub. No.: US 2009/0125832 A1
(43) Pub. Date: May 14, 2009

(54) Information Processing Program an Information Processing Apparatus

(75) Inventor: Yukiko SHIKATA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/264,783

(22) Filed: Nov. 4, 2008

(30) Foreign Application Priority Data
Nov. 13, 2007 (JP) 2007-294170

(51) Int. Cl. G06F 3/048

(52) U.S. Cl. 715/777

(57) ABSTRACT

Provided is an information processing program for executing on a computer a process of displaying a graphical user interface including a plurality of tabs on a predetermined display device, the information processing program executing: a tab screen switching function which receives the selection of a tab and switches the display of the graphical user interface to a tab screen corresponding to the selected tab; a page switch receiving function which receives an instruction for the switch of a page in a state in which the graphical user interface is displayed on a tab screen corresponding to at least one of the plurality of tabs; and an in-tab-screen page switching function which switches the page displayed on the tab screen in a state in which the selection of the tab is maintained, according to the instruction for the switch.

### BACKGROUND

1. Technical Field

The present invention relates to an information processing program and an information processing apparatus, and more particularly, an information processing program and an information processing apparatus for displaying an graphical user interface.

2. Related Art

An information processing apparatus for displaying a dialog box including a plurality of tab pages on a display device is known (see JP-A-2006-133891).

In the dialog box, a tab portion (hereinafter, briefly referred to as a tab) of each of the tab pages is selected by the manipulation of a mouse of a user in one window and the tab page of the selected tab is opened in the window.

The dialog box (graphical user interface (GUI)) is used, for example, for displaying status information of a printer connected to a personal computer (PC) by a tab of each item. With the higher functions of the current printers, information which is displayed in a dialog box tends to increase. In this case, in the related art, the number of tabs of the dialog box was increased in order to cope with the increase of information to be displayed. That is, if all of a large amount of information on of any one item (information on an item such as a consumable good of the printer) cannot be displayed in a tab page corresponding to one tab, the number of tabs for displaying the information on one item was increased to two or three. Meanwhile, the display of the dialog box is generally configured such that the tabs are sequentially arranged from an item which is expected to be most frequently selected and inspected, in descending order, in consideration of the convenience of a user.

In this condition, the following problems occur. If a plurality of tabs exists with respect to a common item, the plurality of tabs are not necessarily equal in the frequency of selection and inspection by the user. Accordingly, if the convenience of the user is considered as described above, the tabs of the common item may not be arranged adjacent to each other in the dialog box. If the tabs of the common item are arranged to be separated from each other in the dialog box, the user may be confused, which is undesirable. That is, although the number of tabs is increased as the amount of information displayed in the dialog box is increased, it is difficult to realize the GUI which satisfies the convenience of the user. If the number of tabs is increased, the display of the tabs arranged in the dialog box falls into disorder and thus the comfortable feeling of the user deteriorates.

### SUMMARY

An advantage of some aspects of the invention is that it provides an information processing program and an information processing apparatus for realizing a GUI which can be comfortably used by a user compared with the related art.

According to an aspect of the invention, there is provided an information processing program for executing on a computer a process of displaying a graphical user interface (GUI) including a plurality of tabs on a predetermined display device. A tab screen switching function receives the selection of a tab and switches the display of the graphical user interface to a tab screen corresponding to the selected tab. A page switch receiving function receives an instruction for the switch of a page in a state in which the GUI is displayed on a tab screen corresponding to at least one of the plurality of tabs. An in-tab-screen page switching function switches the page displayed on the tab screen in a state in which the selection of the tab is maintained, according to the instruction for the switch.

According to the invention, the page can be further switched on the tab screen (tab page) corresponding to the selected tab in the GUI. The amount of information displayed in the GUI can be increased without increasing the number of tabs and thus the convenience or the comfortable feeling can be prevented from deteriorating due to the increase in the number of tabs.

As another example of the invention, the tab screen switching function may display a page, which is recently displayed as a page displayed on the switched tab screen in the past, on the switched tab screen, when the tab screen is switched to the tab screen corresponding to the selected tab. According to this configuration, when the user selects any tab so as to switch the tab screen, the page which is lastly inspected in the past is displayed on the switched tab screen. In order to realize this process, the page which is displayed on the tab screen just before the switch needs to be stored whenever the user switches the tab.

As another example of the invention, the information processing program may further execute a status information acquiring function which acquires status information of a plurality of items of an external device on the computer by communicating with the external device. The tab screen switching function may display the acquired status information of the plurality of items by switching the tab screen according to the selection of the tab, and the in-tab-screen page switching function may display the status information of sub items belonging to one of the plurality of items in a state of being divided into a plurality of pages by switching the page according to the instruction for the switch. According to this configuration, the status information of the external device (for example, the printer) is classified into the items such that the tabs correspond to the items, and the information of the sub items obtained by dividing the items can be displayed on the tab screen by the switch of the page.

As another example of the invention, the tab screen switching function may determine which page is displayed on the basis of contents represented by the status information of the sub items corresponding to the page included in the switched tab screen and display the determined page on the switched tab screen, when the tab screen is switched to the tab screen corresponding to the selected tab. According to this configuration, when any tab is selected and the tab screen is displayed, the page which is first displayed on the tab screen is not fixed. For example, according to the contents of the status information of the external device when the switched tab screen is displayed, a page which needs to be preferentially displayed compared with other pages can be preferentially displayed at that point of time.

As another example of the invention, the status information acquiring function may acquire only the status information corresponding to the sub items displayed on the switched page according to the instruction for the switch from the external device when the page switch receiving function receives the instruction for the switch of the page, and the in-tab-screen page switching function may display the switched page on the basis of the acquired status information of the sub items. According to this configuration, since, among various types of status information of the external device, only information necessary for the display of the switched page on the tab screen is acquired from the external device, the amount of communication with the external device is decreased and thus the switch of the page can be performed at a high speed.

As another example of the invention, the status information acquiring function may not acquire the status information from the external device when the selection of the tab or the instruction for the switch of the page is newly received by the tab screen switching function or the page switch receiving function within a predetermined time from recent reception as the instruction for the switch of the page or the selection of the tab received by the tab screen switching function or the page switch receiving function, and the tab screen switching function or the in-tab-screen page switching function may perform the display on the basis of newest status information of the status information which is acquired in the past. According to this configuration, when the switch of the page or the switch of the tab on the same tab screen is performed in a period shorter than the predetermined time, the display is performed using the acquired status information without acquiring the status information by the communication with the external device. Accordingly, it is possible to prevent a problem in which the communication process with the external information is too frequently performed and thus the processing burden is increased.

The spirit of the invention is applicable to all the GUIs for performing the display using the plurality of tabs. For example, the tab screen switching function may display an input section related to printing conditions of the plurality of items set when a printing process is executed with respect to each item by switching the tab screen according to the selection of the tab, and the in-tab-screen page switching function may display input sections of the sub items belonging to one of the plurality of items in a state of being divided into a plurality of pages by switching the page according to the instruction for the switch. That is, the invention is applicable to the GUI for setting the printing condition of the printer driver displayed on the display device when the user performs printing using the printer.

In the invention, it is possible to provide an information processing apparatus including the configurations corresponding to the functions of the information processing program or an information processing method including the processing steps corresponding to the functions of the information processing program.

### BRIEF DESCRIPTION OF THE DRAWINGS

The invention will be described with reference to the accompanying drawings, wherein like numbers reference like elements.

FIG. 1 is a block diagram showing the hardware configuration of a printing system.

FIG. 2 is a block diagram showing the functional configuration of a computer.

FIG. 3 is a view showing an icon corresponding to a status monitor.

FIG. 4 is a flowchart illustrating a process when an icon receives a predetermined manipulation from a user.

FIG. 5 is a view showing displayed menus.

FIG. 6 is a view showing an example of a dialog box including a plurality of tab pages.

FIG. 7 is a view showing an example of a dialog box including a plurality of tab pages.

FIG. 8 is a flowchart illustrating a process of switching and displaying a page on a tab screen.

### DESCRIPTION OF EXEMPLARY EMBODIMENTS

The embodiments of the invention will be described in the following order with reference to the accompanying drawings.

### (1) Schematic Configuration of Printing System

### (2) Display of GUI

### (3) Modified Examples

### (4) Conclusion

### (1) SCHEMATIC CONFIGURATION OF PRINTING SYSTEM

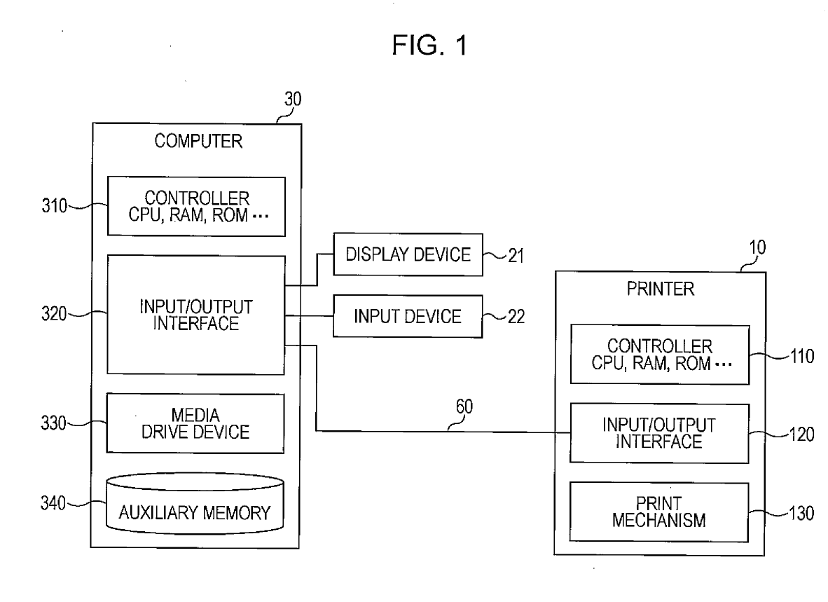

FIG. 1 is a block diagram showing the hardware configuration of a printing system according to an embodiment of the invention. As shown in FIG. 1, the printing system is configured by connecting a host computer (hereinafter, briefly referred to as a computer) 30 for realizing various processes of application software, a printing process of a printer driver and a user interface including an input/output device to a printer 10. In the main body of the computer 30, a display device 21 such as a color display and an input device 22 such as a mouse and a keyboard are connected. The configuration of the printing system is not limited thereto.

In the present embodiment, the computer 30 functions as a printer host for generating printing data, transmitting the printing data to the printer 10 or managing the status of the printer 10, and displaying printer status information (status information).

As the computer 30, for example, a general-purpose information processing apparatus such as a PC may be used. In the present embodiment, the computer 30 includes a controller 310 including a central processing unit (CPU) for executing various types of programs, a random access memory (RAM) for temporarily storing data and programs and a read only memory (ROM) for storing a variety of data for controlling the computer 30 and various types of programs; an input/output interface 320 which is connected to the display device 21, the input device 22 and the printer 10; a media drive device 330 for accessing a recording medium such as a CD-ROM; and an auxiliary memory 340 such as a hard disk. The configuration of the computer 30 is not limited thereto.

A printer driver program and a status monitor program which are computer programs for functioning the computer 30 as the printer host is developed in correspondence with the type of the printer 10 according to the maker of the printer 10 and is distributed in a state of being recorded in the recording medium such as a CD-ROM or is distributed via a computer network such as the Internet. A status monitor program included in a printer driver program may be developed. These programs are installed in the computer 30 and executed so as to realize the following functions. The status monitor program or the printer driver program corresponds to an example of the information processing program of the invention. The computer 30 for executing the status monitor program or the printer driver program corresponds to an example of the information processing apparatus of the invention.

The printer 10 may be, for example, a page printer including a laser print mechanism. The laser page printer includes a toner cartridge in which a toner is contained in casings, and performs printing by transferring this toner onto a printing medium such as printing paper. The printer 10 may be any one of a color laser printer or a monochrome laser printer. Instead of the laser printer, for example, an ink jet printer may be used.

The printer 10 includes a controller 110 which includes a CPU, a RAM and a ROM and controls various types of processes of the printer 10, an input/output interface 120 which is connected to a communication line 60 to be connected to the computer 30, and a print mechanism 130 including a printing tool such as a toner cartridge, a photosensitive body drum or a laser light irradiation mechanism and a feed/ejection mechanism. The configuration of the printer 10 is not limited thereto.

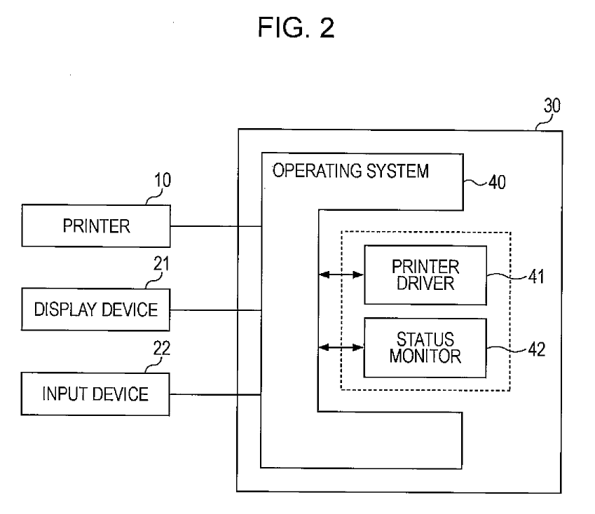

FIG. 2 is a block diagram showing the functional configuration of the computer 30. As shown in FIG. 2, the computer 30 includes an operating system 40, a printer driver 41, and a status monitor 42.

The printer driver 41 and the status monitor 42 are established in the computer 30 in correspondence with the printer 10 connected to the computer 30. The printer driver 41 is realized by the printer driver program and the status monitor 42 is realized by the status monitor program.

The operating system 40 is the basic software for controlling a basic user interface of the computer 30 and the management of files. The operating system 40 employs a GUI and can provide a dialog box including a plurality of tabs. Accordingly, the operating system 40 also functions as a portion of the information processing program of the invention.

The printer driver 41 and the status monitor 42 perform the respective functions on the operating system 40. Accordingly, when the status monitor 42 displays the dialog box including the plurality of tabs and a menu, data having a format decided by the operating system 40 is output to the operating system 40 so as to be displayed on the display device 21.

The printer driver 41 performs a process of printing a document prepared by application software (not shown) by the printer 10.

The status monitor 42 communicates with the printer 10 at a predetermined timing, acquires the status information of the printer 10, and displays the status information on the display device 21 if necessary. The status information of the printer 10 acquired by the status monitor 42 includes, for example, a plurality of items such as an error occurrence information, the status information of an exchange (also referred to as a consumable good), a reception status information of a print job or the like.

The status monitor 42 can acquire the status information of the plurality of items of the printer 10 and thus has a status information acquiring function.

### (2) DISPLAY OF GUI

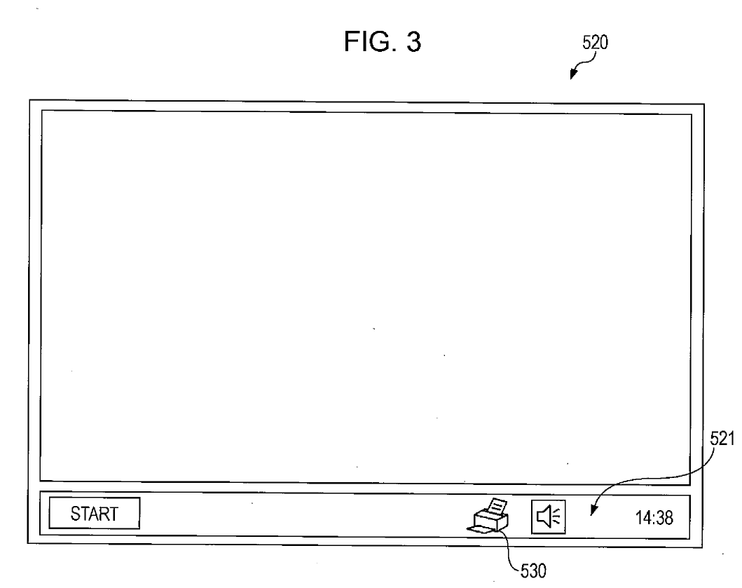

In the present embodiment, when the status monitor program is installed in the computer 30, in an executed program display region 521 (for example, Windows (registered trademark) of Microsoft Corporation), which is provided by the operating system 40, of a display screen 520 of the display device 21 shown in FIG. 3, an icon 530 corresponding to the status monitor 42 is displayed in a task bar (task tray).

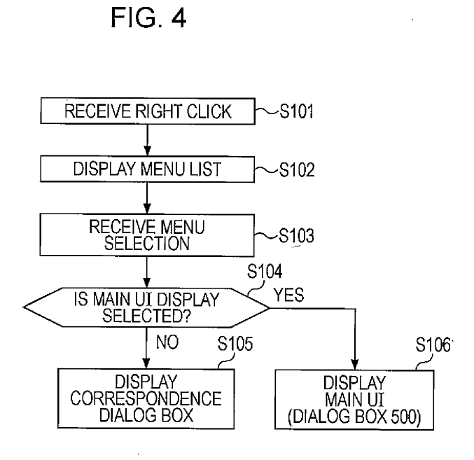

Next, a process when the icon 530 corresponding to the status monitor 42 receives a predetermined manipulation, for example, a right click of the mouse as the input device 22, from the user will be described with reference to the flowchart of FIG. 4.

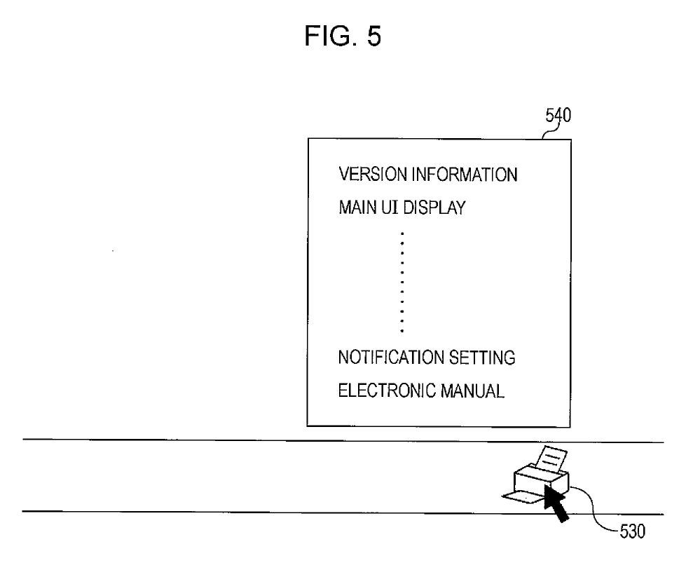

When the icon 530 corresponding to the status monitor 42 receives the right click (S101), the status monitor 42 displays, for example, a menu list 540 shown in FIG. 5 on the display device 21 (S102).

As shown in FIG. 5, in the menu list 540, various types of menus provided by the status monitor program are displayed so as to be selected in the form of a list. Among them, for example, a menu “main UI display” is included. When the selection from the menu list 540 is received from the user (S103), it is determined whether the selected menu is “main UI display” (S104). As a result, if it is determined that the selected menu is not “main UI display” (No of S104), the dialog box corresponding to another menu selected from the menu list 540 is displayed on the display screen 520 (S105). The user can perform predetermined manipulation or inspection of information (for example, the inspection of version information or the like) via the dialog box displayed in the step S105.

Meanwhile, if it is determined that the selected menu is “main UI display” (Yes of S104), the status monitor 42 displays the dialog box on the display screen 520 of the display device 21 as the main UI (S106).

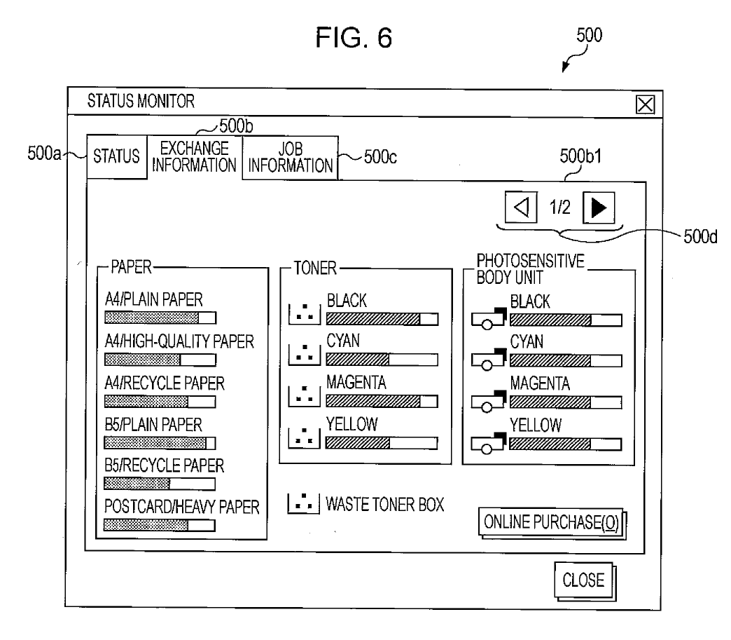

FIG. 6 is a view showing an example of the dialog box 500 as the main UI. In FIG. 6, the dialog box 500 includes three tabs 500a, 500b and 500C respectively corresponding to three items including “status” “exchange information” and “job information”. The tab 500a of “status” corresponds to error occurrence information in each item of the status information. When the user selects the tab 500a by the manipulation of the mouse, the status monitor 42 generates a tab screen for displaying the existence/nonexistence of an error (for example, a paper jam) of the printer 10 or the contents of the error on the basis of the error occurrence information and displays the tab screen on the dialog box 500. At a time point when the dialog box 500 is opened by the selection of the menu from the menu list 540, the tab 500a is basically selected.

The tab 500b of “exchange information” corresponds to the status information of the exchange in each item of the status information. When the user selects the tab 500b, the status monitor 42 generates a tab screen 500b1 for displaying the status such as the consumption degrees of various types of exchanges of the printer 10 on the basis of the exchange status information and displays the tab screen in the dialog box 500. In FIG. 6, the tab 500b is selected and the tab screen 500b1 is displayed.

The tab 500c of “job information” corresponds to the reception status information of a print job in each item of the status information. When the user selects the tab 500c, the status monitor 42 generates a tab screen for displaying the progress status of the print job received by the printer 10, a document name or a user name on the basis of the reception status information of the print job and displays the tab screen in the dialog box 500. Since the dialog box 500 for switching and displaying the tab screen in correspondence with the selected tab can be displayed on the display device 21, the status monitor 42 performs a tab screen switching function.

The display of the information in the dialog box 500 will be described in more detail.

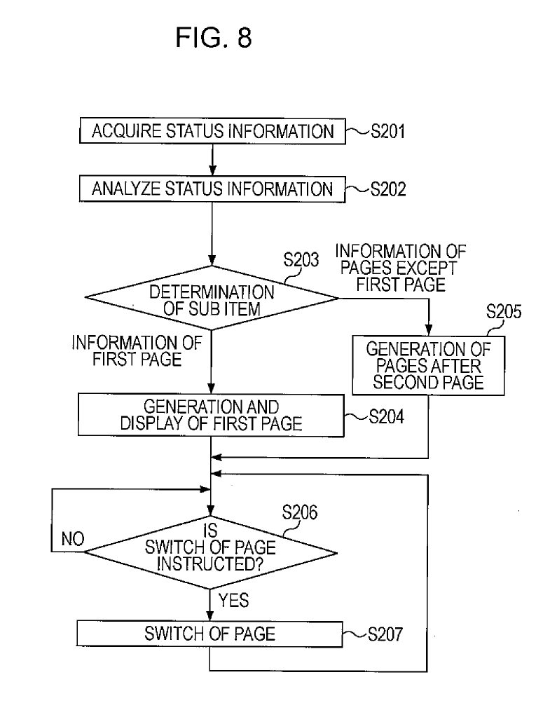

FIG. 8 is a flowchart illustrating a process of switching and displaying a page on the tab screen corresponding to any one tab. The flowchart is executed by the status monitor 42. The flowchart will be performed in a state in which the dialog box 500 is displayed and any one of the tabs 500a, 500b and 500c is selected. Here, it is assumed that the tab 500b is selected.

In a step S201, the status monitor 42 communicates with the printer 10 and acquires the status information from the printer 10.

In a step S202, the status monitor 42 analyzes the acquired status information. The status monitor 42 extracts the information (status information of the exchange) of the item necessary for the display of the tab screen (tab screen 500b1) corresponding to the tab (tab 500b) selected at that time from the status information.

In a step S203, the status monitor 42 determines on which page of the tab screen 500b1 the information of sub items included in the extracted information is displayed. In the present embodiment, the items used for further classifying and displaying the information of the items corresponding to the tabs are called sub items, and the status information (status information of the exchange) of the item corresponding to the tab 500b includes, for example, information of the sub items such as “paper”, “toner”, “photosensitive body unit”, “transfer unit”, “fixing unit”, “maintenance unit” and “ADF maintenance unit”. The status monitor 42 defines in advance the number of pages of the tab screen 500b1 and the correspondence between the pages and the sub items, and causes the information of the sub items included in the extracted information to correspond to the page numbers according to this definition.

In a step S204, the status monitor 42 generates image data of a first page on the basis of the sub items which are determined to be displayed on the first page of the tab screen 500b1 in the step S203 and performs the display of the page based on this image data on the tab screen 500b1. As a result, as shown in FIG. 6, in the tab screen 500b1 (the first page of the tab screen 500b1) opened by selecting the tab 500b, the sub items which will be displayed on the first page, among the sub items belonging to the status information of the exchange in the status information, are displayed. In the example of FIG. 6, the consumption degrees of “paper”, “toner”, and “photosensitive body unit” are displayed on the first page of the tab screen 500b1.

In a step S205, the status monitor 42 generates image data of the pages after the first page, on the basis of the information of the sub items which are determined to be displayed on the pages except the first page of the tab screen 500b1 in the step S203, in page units. At the time point of the step S205, the image data of the pages after the first page is generated and the first page is displayed on the tab screen 500b1. That is, the status monitor 42 substantially simultaneously performs the processes of the steps S204 and S205.

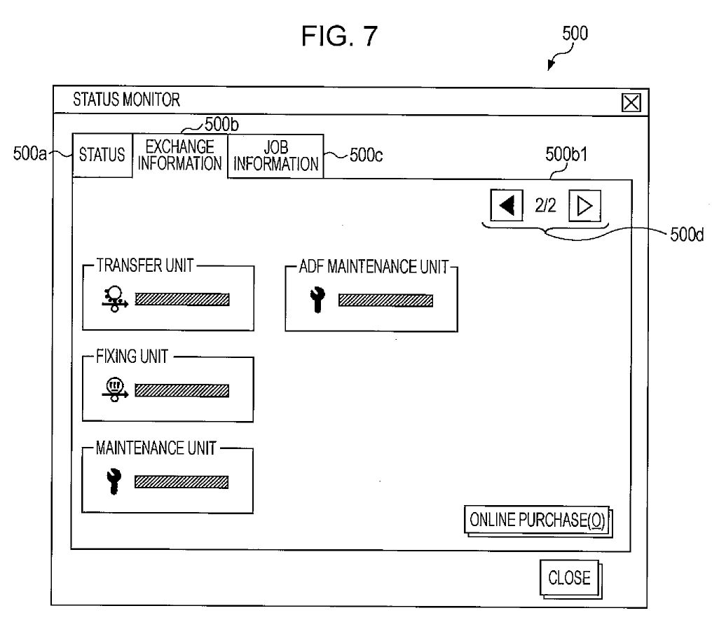

In a step S206, the status monitor 42 determines whether or not an instruction for the switch of the page which is currently being displayed is received. In the present embodiment, as shown in FIGS. 6 and 7, a page movement button 500d is included on the page of the tab screen 500b1. That is, the user clicks the page movement button 500d using the mouse, the page displayed on the tab screen 500b1 can be switched. Since the instruction for the switch of the page can be received via the page movement button 500d, the status monitor 42 performs a page switch reception function.

The status monitor 42 continuously displays the page which is displayed at a time when the instruction for the switch of the page is not received. The status monitor 42 switches the display of the dialog box 500 in respect to the display of the tab screen corresponding to the selected tab, when an input other than the instruction for the switch of the page, for example, the selection of another tab is received.

The status monitor 42 performs a process of switching the page displayed on the tab screen 500b1 according to the instruction for the switch, when the instruction for the switch of the page is received via the page movement button 500d (S207).

FIG. 7 shows the dialog box 500 after the display of the tab screen 500b1 is switched from the first page to a second page. The display of the second page is performed on the basis of the image data generated in the step S205. As shown in FIG. 7, on the second page of the tab screen 500b1, the consumption degrees of “transfer unit”, “fixing unit”, “maintenance unit” and “ADF maintenance unit” of the sub items belonging to the status information of the exchange in the status information are displayed. When the instruction for the switch of the page is received via the page movement button 500d, the page of the tab screen 500b1 can be switched and displayed while the state in which the tab 500b is selected is maintained. Thus, the status monitor 42 performs a page switching function in the tab screen.

Although the information of the sub items is divided and displayed on the tab screen 500b1 over the total two pages in FIGS. 6 and 7, the number of pages which can be switched on one tab screen is not limited. Although the page movement button 500d on the tab screen 500b1 shown in FIGS. 6 and 7 switches the page one page by one page, a button for directly switching the page to a page desired by the user may be used if the number of pages is equal to or greater than three.

Even when the tabs 500a and 500c are selected by the user instead of the tab 500b, the switch and the display of the page in the tab screen can be performed by the same process as FIG. 8.

The timing of acquiring the status information from the printer 10 is not limited to the step S201. The status monitor 42 may periodically communicate with the printer 10 after the step S201, repeatedly acquire new status information from the printer 10, and store the new status information in a predetermined memory (RAM or the like). By this configuration, when the user manipulates the page movement button 500d so as to instruct the switch of the page, the display of the switched page can be performed on the basis of the newest status information stored at that point of time. Alternatively, the status monitor 42 may acquire the newest status information from the printer 10 and perform the display of the switched page on the basis of the acquired status information, whenever the user manipulates the page movement button 500d so as to instruct the switch of the page.

### (3) MODIFIED EXAMPLES

In the present embodiment, various modified examples may be employed as follows.

In the above description, among the pages of the tab screen, the first page is first displayed on the tab screen opened by selecting the tab of the dialog box 500 by the user. However, the first page does not need to be necessarily displayed when the tab screen is opened, and, when the tab is selected, a page which is recently displayed may be displayed by the page displayed on the tab screen of the tab which is selected in the past. In order to realize this configuration, for example, the status monitor 42 stores the number of the page which was lastly displayed on the tab screen of the tab which was previously selected, in a predetermined memory (RAM or the like) whenever any one of the tabs 500a to 500c is selected in the dialog box 500. In addition, the status monitor 42 reads and specifies the number of the page which was lastly displayed on the tab screen of the selected tab whenever any one of the tabs 500a to 500c is selected in the dialog box 500. If the number of the page which was lastly displayed on the tab screen of the selected tab is not stored in the predetermined memory, the status monitor 42 conveniently specifies the number of the page which was lastly displayed as 1.

The status monitor 42 displays the page related to the specified page number on the tab screen of the selected tab. As a result, for example, if the user selects the tab 500c so as to inspect “job information” just after inspecting the second page of the tab screen 500b1 and then selects the tab 500b again so as to return to the tab screen 500b1 or if the user closes the dialog box 500 after inspecting the second page of the tab screen 500b1 and then starts the dialog box 500 again so as to select the tab 500b, the second page for displaying the sub items such as “transfer unit” is displayed in the tab screen 500b1. If the screen which was lastly viewed by the user is preferentially displayed on the tab screen when the tab screen is opened, it is possible to provide the dialog box 500 which satisfies the requirement of the user.

Alternatively, as another modified example, the page which is first displayed when the tab screen is opened may be determined on the basis of the contents (degree) represented by the sub items corresponding to each of the pages included in the tab screen. For example, the status monitor 42 displays a page having a sub item which needs to be urgently informed to the user at that point of time, when the tab screen is opened. In more detail, when the user selects the tab 500b, the status monitor 42 determines a sub item which should be preferentially informed to the user at that point of time among the sub items which can be displayed on the tab screen 500b1, on the basis of the status information and a predetermined determination reference. For example, among the sub items including “paper”, “toner”, “photosensitive body unit”, “transfer unit”, “fixing unit”, “maintenance unit” and “ADF maintenance unit”, a sub item which is closest to the exchange time is specified by analyzing the status information. The status monitor 42 displays the page including the specified sub item on the tab screen 500b1 just after tab 500b is selected. If a plurality of sub items which are close to the exchange time exist, the page with the smallest page number among pages which include these sub items may be displayed.

In the above description, the status monitor 42 acquires the new status information from the printer 10 whenever the instruction for the switch of the page is received by the manipulation of the page movement button 500d. However, if all status information including a plurality of items are received whenever the page is switched, the communication amount of the computer 30 and the printer 10 is significantly increased and thus the time consumed for the display of the page (the switch of the page) on the tab screen is increased. Accordingly, as another modified example of the present embodiment, when the instruction for the switch of the page is received, the status monitor 42 may acquire only the status information corresponding to the sub item displayed on the switched page from the printer 10 and display the switched page on the tab screen on the basis of the acquired status information. For example, when the display of the tab screen 500b1 is switched from the first page to the second page, the status monitor 42 acquires only the information of the sub item (“transfer unit” or the like) necessary for the display of the second page, which is the switched page, of the new status information from the printer 10. As a result, the communication amount between the computer 30 and the printer 10 is decreased and the switch of the page on the tab screen can be performed at a high speed.

In the dialog box 500, the user can switch the page on the tab screen by selecting any one of the tabs 500a to 500c or manipulating the page movement button 500d. As described above, the status monitor 42 can acquire the status information from the printer 10 when the tab is selected and acquire (a portion of) the status information from the printer 10 when the page is switched. However, if the selection of the tab or the switch of the page is too frequently performed by the user, the acquisition of the status information from the printer 10 at that time imposes a heavy burden on both the computer 30 and the printer 10. When the consumption speeds of various types of exchanges are considered, the new status information does not need to be obtained according to the selection of the tab or the switch of the page which is frequently performed.

Accordingly, as another modified example of the present embodiment, when the selection of any one of the tabs 500a to 500c or the instruction for the switch of the page via the page movement button 500d is received, the status monitor 42 may determine whether or not the reception was performed within a predetermined time (for example, several seconds) from the recent selection of the tab or the recent instruction for the switch of the page which was performed in the past. If the reception was performed within the predetermined time, new status information may not be acquired from the printer 10. In this case, instead of the acquisition of the status information from the printer 10, the display of the page on the tab screen of the selected tab or the display of the switched page is performed using newest information of the status information acquired from the printer 10. As a result, it is possible to inform the user of the status of the printer 10 in a necessary range and suppress the processing burden of the computer 30 or the printer 10.

Even in the GUI for setting the printing conditions of the plurality of items (the dialog box for setting the printing conditions) by the user, which is displayed on the display device 21 by the printer driver (printer driver 41), the configuration for switching the page on the tab screen may be employed. In this case, for example, the tab corresponding to the tab screen for displaying a user input section for setting “print paper” or the tab corresponding to the tab screen for displaying a user input section for setting “print layout” are formed in the dialog box. In the tab screen displayed by selecting the tab, for example, the tab screen related to “print layout”, an input section for selecting the user input section (for example, an input section for selecting “one-sided/double-sided print”, an input section for selecting “vertical/horizontal direction” or the like) of each of the plurality of sub items belonging to “print layout” is divided into a plurality of pages and is switched and displayed.

Although a method of switching the page of the tab screen is described as a method of changing the display contents of the tab screen up to now, as the method of changing the display contents of the tab screen, the display contents may be changed by scrolling an image by the manipulation of the user, instead of the switch of the page. The above-described embodiment and the modified examples may be properly combined. Although the invention is applied to the printer host (computer 30) configuring the printing system, the invention is applicable to the display of the GUI having a plurality of tabs using the information processing apparatus.

### (4) CONCLUSION

According to the present embodiment, in the dialog box 500 including the plurality of tabs 500a to 500c, the page movement button 500d is provided on the tab screen 500b1 corresponding to at least one tab 500b, and the instruction for the switch of the page of the user is received via the page movement button 500d such that the switch of the page on the tab screen 500b1 is performed. As a result, although the amount of information displayed in the dialog box 500 is increased, it is possible to readily cope with the increase in the amount of information by increasing the number of pages on the tab screen. Although the increase in the amount of information was coped with by increasing the number of tabs in the past, the increase in the number of tabs is not suitable when the appearance or the convenience of the dialog box is considered. In the present embodiment, the amount of information displayed in the dialog box 500 can be increased without limitation, instead of increasing the number of tabs. Since the detailed information of the common item can be displayed by switching the page under the common tab, the GUI is susceptible to be viewed by the user and is conveniently used.

The entire disclosure of Japanese Patent Application No. 2007-294170, filed Nov. 13, 2007 is expressly incorporated by reference herein.

What is claimed is:

1. An information processing program for executing on a computer a process of displaying a graphical user interface including a plurality of tabs on a predetermined display device, the information processing program executing:
a tab screen switching function which receives the selection of a tab and switches the display of the graphical user interface to a tab screen corresponding to the selected tab;
a page switch receiving function which receives an instruction for the switch of a page in a state in which the graphical user interface is displayed on a tab screen corresponding to at least one of the plurality of tabs; and
an in-tab-screen page switching function which switches the page displayed on the tab screen in a state in which the selection of the tab is maintained, according to the instruction for the switch.

2. The information processing program according to claim 1, wherein the tab screen switching function displays a page, which is recently displayed as a page displayed on the switched tab screen in the past, on the switched tab screen, when the tab screen is switched to the tab screen corresponding to the selected tab.

3. The information processing program according to claim 1, further comprising a status information acquiring function which acquires status information of a plurality of items of an external device by communicating with the external device,
wherein the tab screen switching function displays the acquired status information of the plurality of items by switching the tab screen, according to the selection of the tab, and the in-tab-screen page switching function displays the status information of sub items belonging to one of the plurality of items in a state of being divided into a plurality of pages by switching the page according to the instruction for the switch.

4. The information processing program according to claim 1, further comprising a status information acquiring function which acquires status information of a plurality of items of an external device by communicating with the external device,
wherein the tab screen switching function displays the acquired status information of the plurality of items by switching the tab screen according to the selection of the tab, and the in-tab-screen page switching function displays the status information of sub items belonging to one of the plurality of items in a state of being divided into a plurality of pages, by switching the page according to the instruction for the switch, and
wherein the tab screen switching function determines which page is displayed on the basis of contents represented by the status information of the sub items corresponding to the page included in the switched tab screen and displays the determined page on the switched tab screen, when the tab screen is switched to the tab screen corresponding to the selected tab.

5. The information processing program according to claim 3, wherein the status information acquiring function acquires only the status information corresponding to the sub items displayed on the switched page according to the instruction for the switch from the external device when the page switch receiving function receives the instruction for the switch of the page, and the in-tab-screen page switching function displays the switched page on the basis of the acquired status information of the sub items.

6. The information processing program according to claim 3, wherein the status information acquiring function does not acquire the status information from the external device when the selection of the tab or the instruction for the switch of the page is newly received by the tab screen switching function or the page switch receiving function within a predetermined time from recent reception as the instruction for the switch of the page or the selection of the tab received by the tab screen switching function or the page switch receiving function, and the tab screen switching function or the in-tab-screen page switching function performs the display on the basis of newest status information of the status information which is acquired in the past.

7. The information processing program according to claim 1, wherein the tab screen switching function displays an input section related to printing conditions of the plurality of items set when a printing process is executed with respect to each item by switching the tab screen according to the selection of the tab, and the in-tab-screen page switching function displays input sections of the sub items belonging to one of the plurality of items in a state of being divided into a plurality of pages by switching the page according to the instruction for the switch.

8. An information processing apparatus which displays a graphical user interface including a plurality of tabs on a predetermined display device, the information processing apparatus comprising:
a tab screen switching unit which receives the selection of a tab and switches the display of the graphical user interface to a tab screen corresponding to the selected tab;
a page switch receiving unit which receives an instruction for the switch of a page in a state in which the graphical user interface is displayed on a tab screen corresponding to at least one of the plurality of tabs; and
an in-tab-screen page switching unit which switches the page displayed on the tab screen in a state in which the selection of the tab is maintained, according to the instruction for the switch.
